(19) United States
(12) Patent Application Publication
(10) Pub. No.: US 2013/0343702 A1
(43) Pub. Date: Dec. 26, 2013

(54) OPTICAL FIBER ASSEMBLY HAVING FIBER BRAGG GRATING

(71) Applicants: SHAO-KAI PEI, Tu-Cheng (TW); MING-YANG LIAO, Tu-Cheng (TW); CHIA-YING WU, Tu-Cheng (TW)

(72) Inventors: SHAO-KAI PEI, Tu-Cheng (TW); MING-YANG LIAO, Tu-Cheng (TW); CHIA-YING WU, Tu-Cheng (TW)

(73) Assignee: HON HAI PRECISION INDUSTRY CO., LTD., Tu-Cheng (TW)

(21) Appl. No.: 13/604,629

(22) Filed: Sep. 6, 2012

(30) Foreign Application Priority Data
Jun. 25, 2012 (TW) 101122671

(51) Int. Cl. G02B 6/32; G02B 6/34

(52) U.S. Cl. 385/33

(57) ABSTRACT

An optical fiber assembly includes an optical fiber and a lens. The optical fiber defines a receiving groove in an end surface thereof. The lens is held in the receiving groove and includes a substrate and a Bragg grating. The Bragg grating includes a number of film layers stacked on the substrate.

### BACKGROUND

1. Technical Field

The present disclosure relates to optical fibers and particularly to an optical fiber assembly having a Fiber Bragg grating (FBG).

2. Description of Related Art

FBGs are a distributed Bragg reflector constructed in a fiber core of an optical fiber that reflect particular wavelengths of light but transmits others. The FBGs are manufactured by creating a periodic variation in a refractive index of the fiber core by exposing the fiber core to intense ultraviolet light, which is inconvenient and inefficient.

Therefore, it is desirable to provide an optical fiber assembly, which can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is an isometric schematic view of an optical fiber assembly, according to an embodiment.

FIG. 2 is similar to FIG. 1, but viewed from another angle.

FIG. 3 is a cross-sectional schematic view of a lens of the optical fiber assembly of FIG. 1.

### DETAILED DESCRIPTION

Embodiments of the present disclosure will now be described in detail with reference to the drawing.

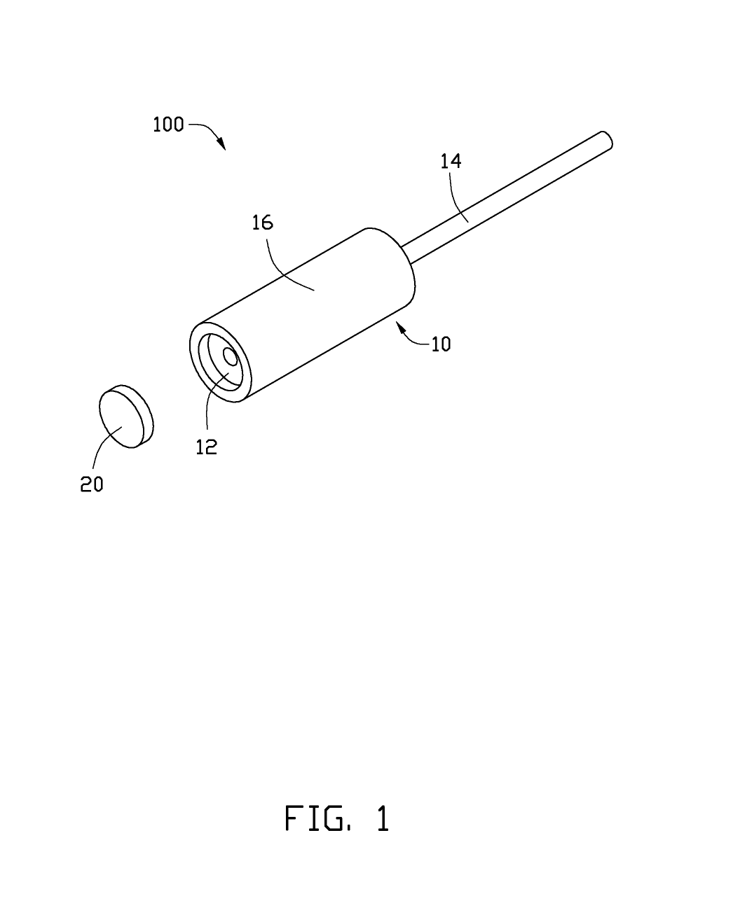

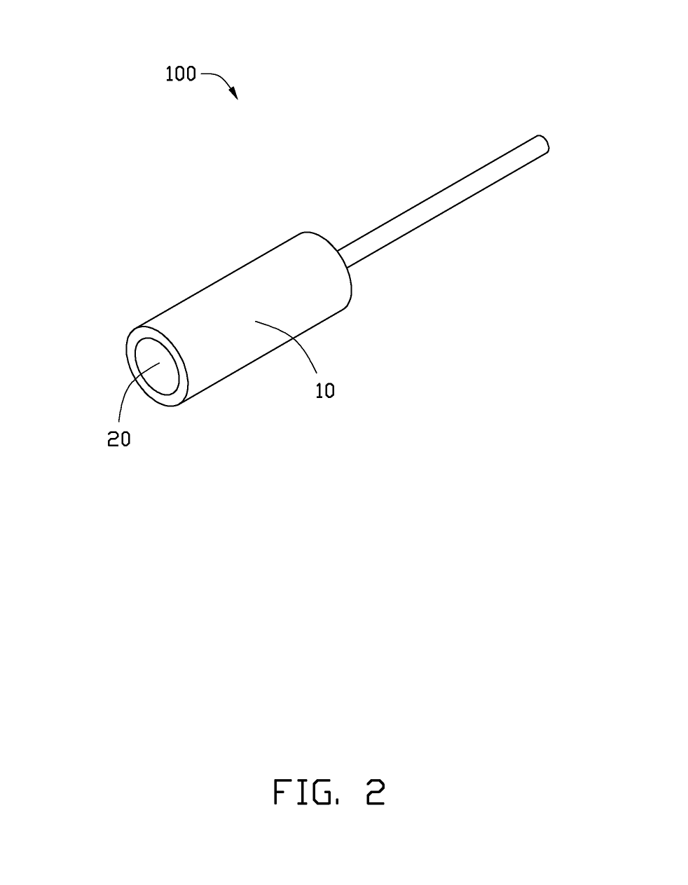

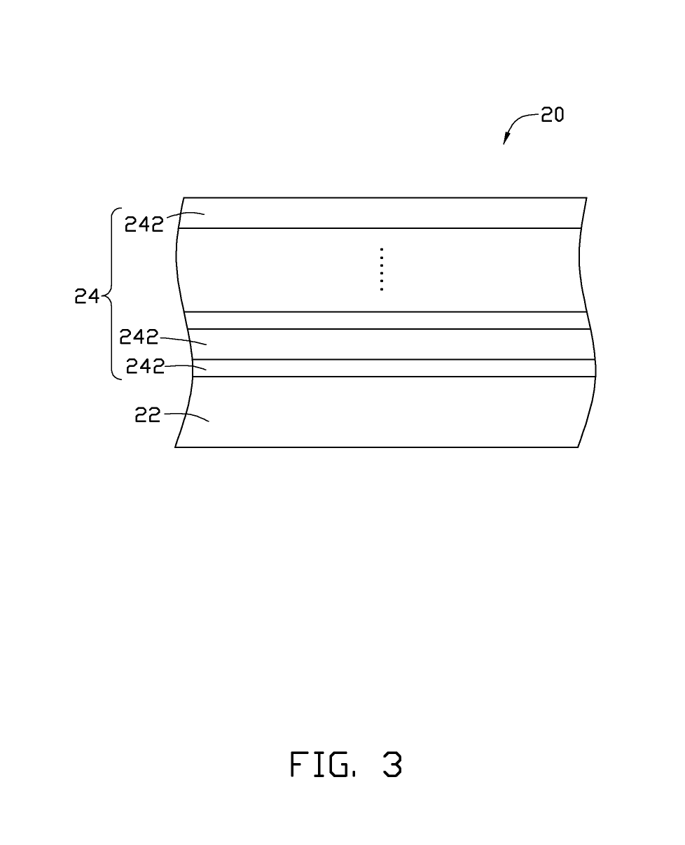

Referring to FIGS. 1-3, an optical fiber assembly 100, according to an embodiment, includes an optical fiber 10 and a lens 20. The optical fiber 10 defines a receiving groove 12 in an end surface thereof. The lens 20 is held in the receiving groove 12 and includes a substrate 22 and a Bragg grating 24. The Bragg grating 24 includes a number of film layers 242 stacked on the substrate 22.

As such, it becomes more convenient and efficient to manufacture the optical fiber assembly 10 as the Bragg grating 24 can formed by known convenient and efficient film deposition technologies.

The optical fiber 10 includes a fiber core 14 and a cladding 16 surrounding the fiber core 14. Both the fiber core 14 and the cladding 16 have substantially circular configurations. The receiving groove 12 is substantially circular too and coaxially formed in the end surface. The receiving groove 12 radially extends from the fiber core 14 to the cladding 16, that is, the diameter of the receiving groove 12 is greater than that of the fiber core 14.

The lens 20 is substantially circular and is firmly held in the receiving groove 12 by an interference fit (i.e., press fit or friction fit), that is, the diameter of the lens 20 is slightly larger than the diameter of the receiving groove 12. However, in alternative embodiments, the lens 20 can be fixed in the receiving groove 12 via adhesive or other technologies other than an interference fit.

The substrate 22 can have refractive power. Thus, the lens 20 and the optical fiber 10 can together function as a lensed fiber. In alternative embodiments, the substrate 22 can be flat, and have no refractive power.

The Bragg grating 24 can be formed by various available deposition methods, such as physical vapor deposition, sputtering, or chemical vapor deposition.

It will be understood that the above particular embodiments are shown and described by way of illustration only. The principles and the features of the present disclosure may be employed in various and numerous embodiment thereof without departing from the scope of the disclosure as claimed. The above-described embodiments illustrate the possible scope of the disclosure but do not restrict the scope of the disclosure.

What is claimed is:

1. An optical fiber assembly, comprising:
an optical fiber defining a receiving groove in an end surface thereof, and
a lens held in the receiving groove and comprising a substrate and a Bragg grating, the Bragg grating comprising a plurality of film layers stacked on the substrate.

2. The optical fiber assembly of claim 1, wherein the optical fiber comprise a fiber core and a cladding surrounding the fiber core, both the fiber core and the cladding have substantially circular configuration, the receiving groove is substantially circular too and coaxially formed in the end surface, and a diameter of the receiving groove is larger than a diameter of the fiber core.

3. The optical fiber assembly of claim 1, wherein both the receiving groove and the lens are substantially circular, a diameter of the lens is slightly larger than the diameter of the receiving groove, the lens is firmly held in the receiving groove by an interference fit.

4. The optical fiber assembly of claim 1, wherein the lens is fixed to the receiving groove via adhesive.

5. The optical fiber assembly of claim 1, wherein the substrate has a refractive power and the optical fiber assembly is a lensed fiber.

6. The optical fiber assembly of claim 1, wherein the film layers are formed by deposition.
